(19) United States
(12) Patent Application Publication
(10) Pub. No.: US 2013/0038916 A1
(43) Pub. Date: Feb. 14, 2013

(54) METHOD OF MAKING MULTIPLEXED TRANSMISSION HOLOGRAMS

(71) Applicants: Mark Cheverton, Mechanicville, NY (US); Sumeet Jain, Schenectady, NY (US); Moitreyee Sinha, New York, NY (US); Andrew Burns, Niskayuna, NY (US); Michael Takemori, Rexford, NY (US); Victor Ostroverkhov, Ballston Lake, NY (US)

(72) Inventors: Mark Cheverton, Mechanicville, NY (US); Sumeet Jain, Schenectady, NY (US); Moitreyee Sinha, New York, NY (US); Andrew Burns, Niskayuna, NY (US); Michael Takemori, Rexford, NY (US); Victor Ostroverkhov, Ballston Lake, NY (US)

(73) Assignee: SABIC INNOVATIVE PLASTICS IP B.V., Bergen op Zoom (NL)

(21) Appl. No.: 13/208,062

(22) Filed: Aug. 11, 2011

(51) Int. Cl. G03H 1/26

(52) U.S. Cl. 359/2; 359/22

(57) ABSTRACT

A method for recording a volume transmission hologram having multiplexed diffraction fringe patterns that can cooperate to display polychromatic images and can be recorded with a single wavelength exposure source.

### BACKGROUND

The present disclosure relates to holograms, methods of making and using holograms, and more particularly to polychromatic holograms. Articles incorporating the polychromatic holograms are also disclosed.

Volume holograms are an increasingly popular mechanism for the authentication of genuine articles, whether it is for security purposes or for brand protection. The use of volume holograms for these purposes is driven primarily by the relative difficulty with which they can be duplicated. Volume holograms are created by interfering two coherent beams of light to create an interference pattern and storing that pattern in a holographic recording medium. Information or imagery can be stored in a hologram by imparting the data or image to one of the two coherent beams prior to their interference. The hologram can be read out by illuminating it with a beam of light matching the geometry and wavelength of either of the two original beams used to create the hologram and any data or images stored in the hologram will be displayed. As a result of the complex methods required to record holograms, their use for authentication can be seen on articles such as credit cards, software, passports, clothing, and the like.

The most common types of volume holograms are transmission holograms and reflection holograms. To form any volume hologram, two light beams are used. One beam, known as the signal beam, carries the image information to be encoded in the hologram. The second beam can be a plane wave or a convergent/divergent beam with no information, also known as the reference beam. The object (or signal) beam and the reference beam generate an interference pattern, which is recorded in the form of a diffraction grating within the holographic medium.

To record a reflection hologram, the reference beam and the object beam illuminate the holographic medium from opposite sides, and the hologram is viewed from the same side of the material as it is illuminated. Generally, a reflection hologram only reflects light within a narrow band of wavelengths around the writing wavelength. Because of this, the holographic image created by a reflection hologram tends to appear monochromatic. The interference fringes in the holographic material are formed by standing waves generated when the two beams, traveling in opposite directions, interact, and the fringes formed are in layers that tend to be substantially parallel to the surface of the film. Generally, such fringes will only reflect wavelengths that are the same as or close to the fringe spacing of the hologram, resulting in a hologram that appears monochromatic.

A transmission hologram is created when both object and reference beams are incident on the holographic medium from the same side, and is so called because in viewing the hologram, the light must pass through the holographic material to the viewer. Transmission holograms are recorded by exposing a holographic recording medium to signal and reference beams from the same side of the recording medium, which tends to produce interference fringes at relatively steep angles with respect to the surface of the film. Such interference fringes can diffract light at wavelengths that are different from the recording wavelength, but at a given viewing angle the hologram will still appear as monochromatic.

While volume holograms can provide more security against counterfeit duplication than surface relief structure holograms, it would be desirable to increase the security of volume holograms. Increasing the complexity of a volume hologram incorporated into the structure of a product could result in a hologram that would serve as a more powerful authenticity tool. Increased complexity of volume holograms may also be desirable for aesthetic reasons or for enhanced information storage capacity.

There remains a need for improved methods of making transmission holograms. More particularly, there remains a need for simpler, more cost effective methods of making complex, e.g., multicolor, holograms.

### SUMMARY

Disclosed herein are methods of making polychromatic holograms and articles comprising the polychromatic holograms, and methods for use thereof.

In an exemplary embodiment, a method for recording a volume transmission hologram is described. According to this method, a first interference fringe pattern is recorded in a holographic recording medium by exposing the holographic recording medium to a signal coherent light source emitting light at a wavelength W and having an angle of incidence with the holographic recording medium of θ_{S1} while simultaneously exposing the holographic recording medium to a mutually coherent reference light source on the same side of the holographic recording medium as the signal coherent light source, the reference coherent light source emitting light at the wavelength W and having an angle of incidence with the holographic recording medium of θ_{R1}. A second interference fringe pattern is recorded in the holographic recording medium by exposing the holographic recording medium to a signal coherent light source emitting light at the wavelength W and having an angle of incidence with the holographic recording medium of θ_{S2} while simultaneously exposing the holographic recording medium to a mutually coherent reference light source on the same side of the holographic recording medium as the signal coherent light source, the reference coherent light source emitting light at the wavelength W and having an angle of incidence with the holographic recording medium of θ_{R2}, wherein at least one of θ_{S1} and θ_{R1} is different from θ_{S2} and θ_{R2}, respectively.

### DESCRIPTION OF THE FIGURES

Referring now to the figures, which are exemplary embodiments and wherein like elements are numbered alike:

FIG. 1 depicts a typical apparatus configuration for the recording of a volume transmission hologram; and

FIG. 2 illustrates an exemplary Bragg diagram for recording of a volume transmission hologram.

### DETAILED DESCRIPTION

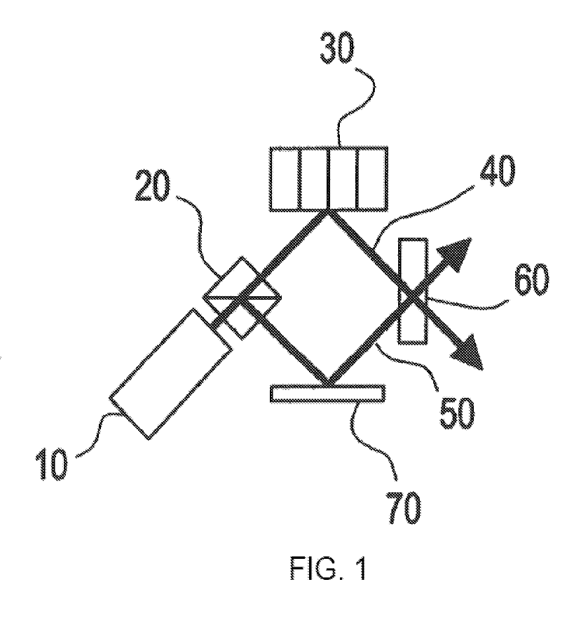

A typical configuration of a system for recording a volume transmission hologram is shown in FIG. 1. In this configuration, the output from a laser 10 is divided into two equal beams by beam splitter 20. One beam, the signal beam 40, is incident on a form of spatial light modulator (SLM), deformable mirror device (DMD), mask, or object to be recorded 30, which imposes the data to be stored in signal beam 40. An SLM or DMD device may be composed of a number of pixels that can block or transmit the light based upon input electrical signals. Each pixel can represent a bit or a part of a bit (a single bit can consume more than one pixel of the SLM or DMD 30) of data to be stored. The output of SLM/DMD/mask/object 30 is then incident on the storage medium 60. The second beam, the reference beam 50, is transmitted all the way to storage medium 60 by reflection off the first mirror 70 with minimal distortion. The two beams have a phase relationship such that they are mutually coherent, and are coincident on the same area of holographic medium 60 at different angles. The net result is that the two beams create an interference pattern at their intersection in the holographic medium 60. The interference pattern is a unique function of the data imparted to signal beam 40 by SLM/DMD/mask/object 30.

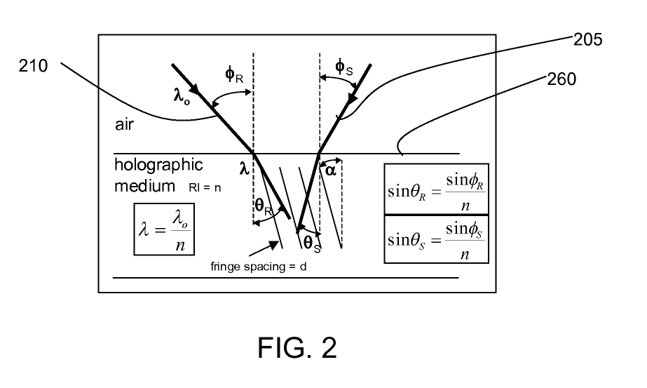

The methods described herein rely at least in part on the ability of a transmission volume hologram to diffract a relatively wide range of different wavelengths at different angles. The optical light path geometry involved in the recording of an exemplary transmission reflection hologram is illustrated in FIG. 2. In FIG. 2, a 405 nm signal light beam 205 and reference light beam 210 impinge on the surface of holographic recording medium 260 at angles of incidence of Φ_{S} and Φ_{R}, respectively. After entering the recording medium with a refractive index n, the light beams are diffracted to a reference internal angle of incidence θ_{R} and a signal internal angle of incidence θ_{S} and pursuant to Bragg's Law, produce a diffraction grating having a fringe spacing d and a fringe angle α. In an exemplary embodiment of a symmetrical case where Φ_{S}=Φ_{R}=35°, the corresponding internal angles become θ_{S}=θ_{R}=21.3° and the resultant diffraction grating has a fringe spacing d=353 nm with fringe angle α=0°. This diffraction grating, once recorded, can subsequently diffract light over a range of wavelengths depending on the viewing angle and the angle at which the viewing light impinges on the grating. The maximum and minimum light wavelengths at which the diffraction grating can be viewed can be calculated by Bragg's Law. For this symmetrical embodiment, the minimum viewable wavelength is vanishingly small at or below the range of the visible spectrum and occurs when the angle of incidence of the illuminating light and the viewing angle each approach 0°. The longest wavelength of 706 nm occurs at the critical angle of 39.3° for total internal reflection in the holographic recording medium having a refractive index of 1.58, which occurs as the angles of illumination and viewing each approach 90°. Due to the wide range of wavelengths that can be diffracted by volume transmission holograms at different angles, they are often called ‘rainbow holograms’.

In the exemplary embodiments described herein, it has now been discovered that polychromic holograms can be created using an exposure light source that emits light at a wavelength W. As described herein, a first interference fringe pattern is recorded in a holographic recording medium by exposing the holographic recording medium to a signal coherent light source emitting light at a wavelength W and having an angle of incidence with the holographic recording medium of θ_{S1}. At the same time, the holographic recording medium is exposed to a converging reference coherent light source on the same side of the holographic recording medium as the signal coherent light source, also emitting light at the wavelength W and having an angle of incidence with the holographic recording medium of θ_{R1}. A second interference fringe pattern is then recorded in the holographic recording medium by exposing the holographic recording medium to mutually coherent signal and reference light sources emitting light at the wavelength W at angles of θ_{S2} and θ_{R2}, with at least one of θ_{S1} and θ_{R1} being different from θ_{S2} and θ_{R2}, respectively.

The polychromic transmission holograms described herein have the property of generating multiple colors when viewed from a given viewing angle of perspective, even though only one color laser was used to record the hologram. The color transmission holograms can include volume holograms containing reconstruction patterns of red, green, and blue, as well as sub-combinations thereof. Alternative color combinations may be utilized as well, depending on the desired effect. In an exemplary embodiment, the multiple fringe patterns in the hologram cooperate to form a predetermined display feature when viewed from at least one viewing angle available to the viewer. In a further exemplary embodiment, the predetermined display feature is a recognizable polychromic image such as a full color image formed by three angularly and spatially multiplexed fringe patterns that diffract red light, green light, and blue light, respectively.

In order to enable the multiple fringe patterns created according to the embodiments described herein to satisfy the Bragg equations while viewing polychromic holograms from a given angle, the viewing illumination used to view the multiple fringe patterns formed as described herein should illuminate at the desired multiple wavelengths for viewing the polychromic hologram, and should also provide illumination at multiple angles. The Bragg equations can be characterized as follows:

$$d = \frac{λ}{2 sin ( \frac{{θ}_{R} + {θ}_{S}}{2} )}$$

$$α = \frac{{θ}_{S} - {θ}_{R}}{2}$$

where θ_{S} is the internal angle of incidence of the signal beam during exposure (or the internal viewing angle during viewing), θ_{R} is the internal angle of incidence of the reference beam during exposure (or the internal angle of illumination during viewing), λ is the internal exposure wavelength or the internal illumination wavelength, d is the fringe spacing, and α is the fringe angle. In an exemplary embodiment, this is accomplished by illuminating the hologram with non-collimated light. The source of non-collimated light source can be a diffuse white light source, although other non-collimated light sources that emit at less than all visible wavelengths and only at defined (but multiple) angles. Multiple collimated light sources at different angles can also be used as a source of non-collimated light. When using a non-collimated light source, the distance between the light source and the hologram may need to be controlled to produce the requisite multiple angles of illumination, with closer distances and larger area illumination sources producing wider ranges of illumination angles. In an exemplary embodiment, the angle of illumination for the different fringe patterns will range from 45° to 54.7° for a two-color image (e.g., green to red) and from 39.4° to 54.7° for a three-color image (e.g., blue to red) (note that these values are somewhat arbitrary and can vary depending on the writing geometry). In another exemplary embodiment, a conventional white LED light source with a diffuser interposed between the light source and the holographic medium is used as the illumination source, positioned approximately 2.5 cm from the holographic medium.

As mentioned above, at least one of the signal exposure angle of incidence and/or the reference exposure angle of incidence is changed between the recording of the different fringe patterns that can combine to display polychromic holograms upon viewing. This can be accomplished through the use of optics controls such as mirrors and lenses to vary the angles of incidence of either or both of the signal and reference beams. In another exemplary embodiment, however, the angles of incidence can be easily changed by rotating the holographic recording medium relative to the direction of the signal and reference light sources between recording of the first and second (and subsequent) recordings of fringe patterns. The specific angles of incidence for the signal and reference light sources that are used to record the multiple fringe patterns will vary depending on the desired polychromic effect to be achieved upon viewing and the targeted viewing angle, and can readily be calculated by one of ordinary skill in the art using the Bragg equation. For example, if a 405 nm laser is used to create a hologram using a reference beam with incident angle Φ_{R}=36.4° and signal beam with incident angle Φ_{S}=2.7° it will create a set of diffraction gratings inside a holographic medium of refractive index n=1.58 with 724.5 nm fringe spacings oriented at 11.9°. If the holographic medium is now rotated clockwise by 2.4° such that the incident angles become Φ_{R}=38.8° and Φ_{S}=5.1°, then a second set of diffraction gratings will be written inside the holographic medium with 732.2 nm fringe spacings oriented at 13.3°. If the holographic medium were rotated clockwise an additional 3.9°, then a third set of diffraction gratings will be written inside the holographic medium with 747.1 nm fringe spacings oriented at 15.6°. These three sets of fringes would be angularly multiplexed in the same spatial location. During viewing the resultant multiplexed hologram, the first set of fringes would then diffract 470 nm (blue) light incident at 39.4° to a transmitted angle normal to the holographic medium, while the second and third set of fringes would diffract 532 nm (green) and 633 nm (red) light to the same transmitted normal angle, thus creating the desired multi-colored image.

When light containing the multiple wavelengths (e.g., white light) is applied to the transmission holograms described herein, the transmission hologram can be observed visually from the side of the hologram opposite the side of incidence (i.e., opposite the side of the article where the light is incident on the article). In another exemplary embodiment, a specular reflective layer on the side of the hologram opposite the illumination side can allow for viewing of the hologram from the same side as the illumination (i.e., a pseudo-reflection hologram).

A polychromic transmission hologram as described herein can be used as a security feature to provide a way of verifying the authenticity of the article. The specific content of the hologram will therefore depend on the needs of the user. When using a hologram to provide authenticity, it may be beneficial that the image is directly interpretable by the human eye when properly viewed to display an image, in other words, interpretable without the aid of a reading machine/computer. The holographic image can have the form of a picture(s), text, numbers, digital data, and other grouping or readily distinguished symbol(s), as well as combinations comprising at least one of the foregoing, such as alphanumeric code and/or a multiplicity of images.

The methods disclosed herein may be utilized with virtually any type of recording medium capable of recording interference fringe patterns for the recording of holograms. Such media may include media that comprise photochemically active dye(s) dispersed in a binder such as a thermoplastic binder as disclosed, for example, in U.S. patents or published patent applications US 2006/0078802A1, US 2007/0146835A1, U.S. Pat. No. 7,524,590, U.S. Pat. No. 7,102,802, US 2009/0082580A1, US 2009/0081560A1, US 2009/0325078A1, and US 2010/0009269A1, the disclosures of which are incorporated herein by reference in their entirety. Other media with which the methods disclosed herein may be used include photopolymer holographic recording media (as disclosed in e.g., U.S. Patents U.S. Pat. No. 7,824,822 B2, U.S. Pat. No. 7,704,643 B2, U.S. Pat. No. 4,996,120 A, U.S. Pat. No. 5,013,632 A), dichromated gelatin, liquid crystal materials, photographic emulsions, and others as disclosed in P. Hariharan, Optical Holography—Principles, techniques, and applications 2^{nd} ed., Cambridge University Press, 1996, the disclosures of each of which are incorporated herein by reference in their entirety.

Many holographic recording media include a photosensitive material (e.g., a photoreactive dye, photopolymer, photographic emulsion, dichromated gelatin, etc.). In an exemplary embodiment, the holographic recording medium may be a composition comprising a binder and the photochemically active material (e.g., photoreactive dye) that is capable of recording a hologram. The binder composition can include inorganic material(s), organic material(s), or a combination of inorganic material(s) with organic material(s), wherein the binder has sufficient deformability (e.g., elasticity and/or plasticity) to enable the desired number of deformation states (e.g., number of different deformation ratios) for the desired recording. The binder should be an optically transparent material, e.g., a material that will not interfere with the reading or writing of the hologram. As used herein, the term “optically transparent” means that an article (e.g., layer) or a material capable of transmitting a substantial portion of incident light, wherein a substantial portion can be greater than or equal to 70% of the incident light. The optical transparency of the layer may depend on the material and the thickness of the layer. The optically transparent holographic layer may also be referred to as a holographic layer.

Exemplary organic materials include optically transparent organic polymer(s) that are elastically deformable. In one embodiment, the binder composition comprises elastomeric material(s) (e.g., those which provide compressibility to the holographic medium). Exemplary elastomeric materials include those derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of elastomeric materials can be used.

Possible elastomeric materials include thermoplastic elastomeric polyesters (commonly known as TPE) include polyetheresters such as poly(alkylene terephthalate)s (particularly poly[ethylene terephthalate] and poly[butylene terephthalate]), e.g., containing soft-block segments of poly(alkylene oxide), particularly segments of poly(ethylene oxide) and poly(butylene oxide); and polyesteramides such as those synthesized by the condensation of an aromatic diisocyanate with dicarboxylic acids and a carboxylic acid-terminated polyester or polyether prepolymer. One example of an elastomeric material is a modified graft copolymer comprising (i) an elastomeric (i.e., rubbery) polymer substrate having a glass transition temperature (Tg) less than 10° C., more specifically less than −10° C., or more specifically −200° to −80° C., and (ii) a rigid polymeric superstrate grafted to the elastomeric polymer substrate. Exemplary materials for use as the elastomeric phase include, for example, conjugated diene rubbers, for example polybutadiene and polyisoprene; copolymers of a conjugated diene with less than 50 wt % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl(meth)acrylates; elastomeric copolymers of C₁₋₈ alkyl(meth)acrylates with butadiene and/or styrene; or combinations comprising at least one of the foregoing elastomers. Exemplary materials for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate. As used herein, the term “(meth)acrylate” encompasses both acrylate and methacrylate groups.

Specific exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

Exemplary organic materials that can also be employed as the binder composition are optically transparent organic polymers. The organic polymer can be thermoplastic polymer(s), thermosetting polymer(s), or a combination comprising at least one of the foregoing polymers. The organic polymers can be oligomers, polymers, dendrimers, ionomers, copolymers such as for example, block copolymers, random copolymers, graft copolymers, star block copolymers; or the like, or a combination comprising at least one of the foregoing polymers. Exemplary thermoplastic organic polymers that can be used in the binder composition include, without limitation, polyacrylates, polymethacrylates, polyesters (e.g., cycloaliphatic polyesters, resorcinol arylate polyester, and so forth), polyolefins, polycarbonates, polystyrenes, polyamideimides, polyarylates, polyarylsulfones, polyethersulfones, polyphenylene sulfides, polysulfones, polyimides, polyetherimides, polyetherketones, polyether etherketones, polyether ketone ketones, polysiloxanes, polyurethanes, polyethers, polyether amides, polyether esters, or the like, or a combination comprising at least one of the foregoing thermoplastic polymers (either in admixture or co- or graft-polymerized), such as polycarbonate and polyester.

Exemplary polymeric binders are described herein as “transparent”. Of course, this does not mean that the polymeric binder does not absorb any light of any wavelength. Exemplary polymeric binders need only be reasonably transparent in wavelengths for exposure and viewing of a holographic image so as to not unduly interfere with the formation and viewing of the image. In an exemplary embodiment, the polymer binder has an absorbance in the relevant wavelength ranges of less than 0.2. In another exemplary embodiment, the polymer binder has an absorbance in the relevant wavelength ranges of less than 0.1. In yet another exemplary embodiment, the polymer binder has an absorbance in the relevant wavelength ranges of less than 0.01. Organic polymers that are not transparent to electromagnetic radiation can also be used in the binder composition if they can be modified to become transparent. For examples, polyolefins are not normally optically transparent because of the presence of large crystallites and/or spherulites. However, by copolymerizing polyolefins, they can be segregated into nanometer-sized domains that cause the copolymer to be optically transparent.

In one embodiment, the organic polymer and photoreactive dye can be chemically attached. The photoreactive dye can be attached to the backbone of the polymer. In another embodiment, the photoreactive dye can be attached to the polymer backbone as a substituent. The chemical attachment can include covalent bonding, ionic bonding, or the like.

Examples of cycloaliphatic polyesters for use in the binder composition are those that are characterized by optical transparency, improved weatherability and low water absorption. It is also generally desirable that the cycloaliphatic polyesters have good melt compatibility with the polycarbonate resins since the polyesters can be mixed with the polycarbonate resins for use in the binder composition. Cycloaliphatic polyesters are generally prepared by reaction of a diol (e.g., straight chain or branched alkane diols, and those containing from 2 to 12 carbon atoms) with a dibasic acid or an acid derivative.

Polyarylates that can be used in the binder composition refer to polyesters of aromatic dicarboxylic acids and bisphenols. Polyarylate copolymers include carbonate linkages in addition to the aryl ester linkages, known as polyester-carbonates. These aryl esters may be used alone or in combination with each other or more particularly in combination with bisphenol polycarbonates. These organic polymers can be prepared, for example, in solution or by melt polymerization from aromatic dicarboxylic acids or their ester forming derivatives and bisphenols and their derivatives.

Blends of organic polymers may also be used as the binder composition for the holographic devices. Specifically, organic polymer blends can include polycarbonate (PC)-poly(1,4-cyclohexane-dimethanol-1,4-cyclohexanedicarboxylate) (PCCD), PC-poly(cyclohexanedimethanol-co-ethylene terephthalate) (PETG), PC-polyethylene terephthalate (PET), PC-polybutylene terephthalate (PBT), PC-polymethylmethacrylate (PMMA), PC-PCCD-PETG, resorcinol aryl polyester-PCCD, resorcinol aryl polyester-PETG, PC-resorcinol aryl polyester, resorcinol aryl polyester-polymethylmethacrylate (PMMA), resorcinol aryl polyester-PCCD-PETG, or the like, or a combination comprising at least one of the foregoing.

Binary blends, ternary blends and blends having more than three resins may also be used in the polymeric alloys. When a binary blend or ternary blend is used in the polymeric alloy, one of the polymeric resins in the alloy may comprise about 1 to about 99 weight percent (wt %) based on the total weight of the composition. Within this range, it is generally desirable to have the one of the polymeric resins in an amount greater than or equal to about 20, preferably greater than or equal to about 30 and more preferably greater than or equal to about 40 wt %, based on the total weight of the composition. Also desirable within this range, is an amount of less than or equal to about 90, preferably less than or equal to about 80 and more preferably less than or equal to about 60 wt % based on the total weight of the composition. When ternary blends of blends having more than three polymeric resins are used, the various polymeric resins may be present in any desirable weight ratio.

Exemplary thermosetting polymers that may be used in the binder composition include, without limitation, polysiloxanes, phenolics, polyurethanes, epoxies, polyesters, polyamides, polyacrylates, polymethacrylates, or the like, or a combination comprising at least one of the foregoing thermosetting polymers. In one embodiment, the organic material can be a precursor to a thermosetting polymer.

As noted above, the photoactive material can be a photoreactive dye. The photoreactive dye is one that is capable of being written and read by electromagnetic radiation. When exposed to electromagnetic radiation of the appropriate wavelength, the dye undergoes a chemical change in situ and does not rely on diffusion of a photoreactive species during exposure to generate refractive index contrast. In one exemplary embodiment, the photoreactive dyes can be written and read using actinic radiation i.e., from about 350 to about 1,100 nanometers. In a more specific embodiment, the wavelengths at which writing and reading are accomplished may be from about 400 nanometers to about 800 nanometers. In one exemplary embodiment, the reading and writing and is accomplished at a wavelength of about 400 to about 600 nanometers. In another exemplary embodiment, the writing and reading are accomplished at a wavelength of about 400 to about 550 nanometers. In one specific exemplary embodiment, a holographic medium is adapted for writing at a wavelength of about 405 nanometers. In such a specific exemplary embodiment, reading may be conducted at a wavelength of about 532 nanometers, although viewing of holograms may be conducted at other wavelengths depending on the viewing and illumination angles, and the diffraction grating spacing and angle. Examples of photoreactive dyes include diarylethenes, dinitrostilbenes and nitrones.

An exemplary diarylethylene compound can be represented by formula (XI):

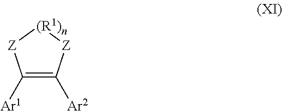

wherein n is 0 or 1; R¹ is a single covalent bond (Cₒ), C₁-C₃ alkylene, C₁-C₃ perfluoroalkylene, oxygen; or —N(CH₂)ₓCN wherein x is 1, 2, or 3; when n is 0, Z is C₁-C₅ alkyl, C₁-C₅ perfluoroalkyl, or CN; when n is 1, Z is CH₂, CF₂, or C═O; Ar¹ and Ar² are each independently i) phenyl, anthracene, phenanthrene, pyridine, pyridazine, 1H-phenalene or naphthyl, substituted with 1-3 substituents wherein the substituents are each independently C₁-C₃ alkyl, C₁-C₃ perfluoroalkyl, or fluorine; or ii) represented by following formulas:

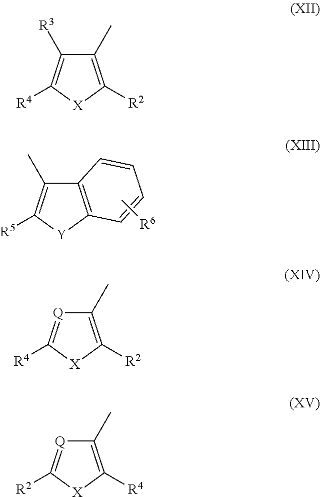

wherein R² and R⁵ are each independently C₁-C₃ alkyl or C₁-C₃ perfluoroalkyl; R³ is C₁-C₃ alkyl, C₁-C₃ perfluoroalkyl, hydrogen, or fluorine; R⁴ and R⁶ are each independently C₁-C₃ alkyl, C₁-C₃ perfluoroalkyl, CN, hydrogen, fluorine, phenyl, pyridyl, isoxazole, —CHC(CN)₂, aldehyde, carboxylic acid, —(C₁-C₅ alkyl)COOH or 2-methylenebenzo[d][1,3]dithiole; wherein X and Y are each independently oxygen, nitrogen, or sulfur, wherein the nitrogen is optionally substituted with C₁-C₃ alkyl or C₁-C₃ perfluoroalkyl; and wherein Q is nitrogen.

Examples of diarylethenes that can be used as photoactive materials include diarylperfluorocyclopentenes, diarylmaleic anhydrides, diarylmaleimides, or a combination comprising at least one of the foregoing diarylethenes. The diarylethenes are present as open-ring or closed-ring isomers. In general, the open ring isomers of diarylethenes have absorption bands at shorter wavelengths. Upon irradiation with ultraviolet light, new absorption bands appear at longer wavelengths, which are ascribed to the closed-ring isomers. In general, the absorption spectra of the closed-ring isomers depend on the substituents of the thiophene rings, naphthalene rings or the phenyl rings. The absorption structures of the open-ring isomers depend upon the upper cycloalkene structures. For example, the open-ring isomers of maleic anhydride or maleimide derivatives show spectral shifts to longer wavelengths in comparison with the perfluorocyclopentene derivatives.

Examples of diarylethene closed ring isomers include:

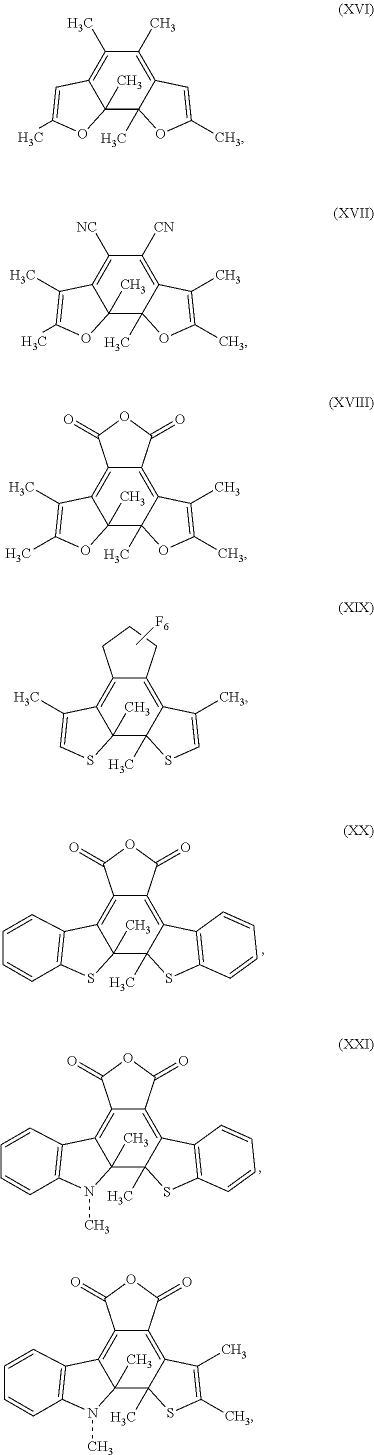

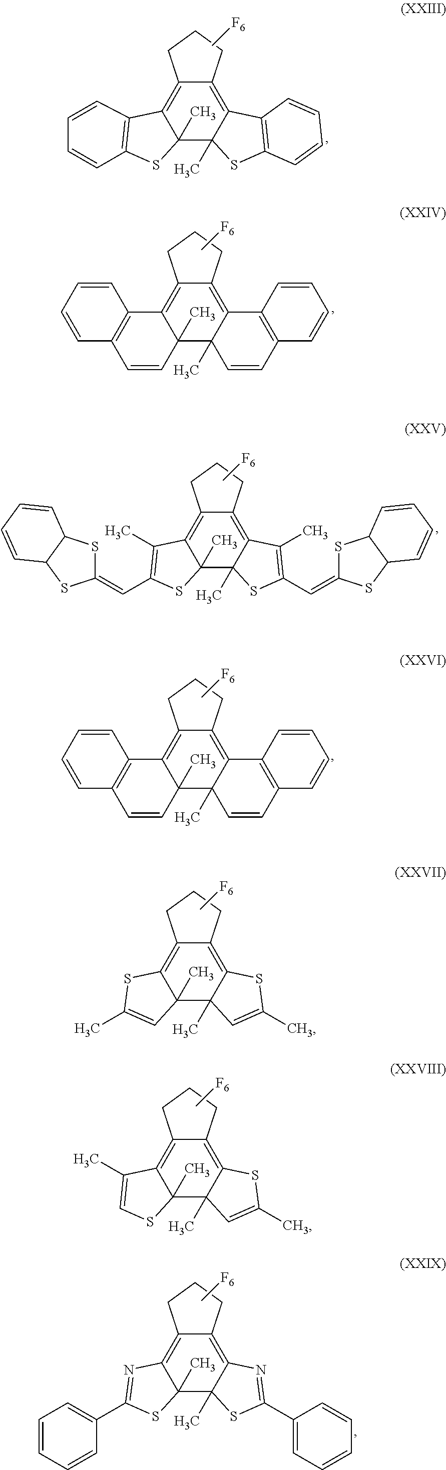

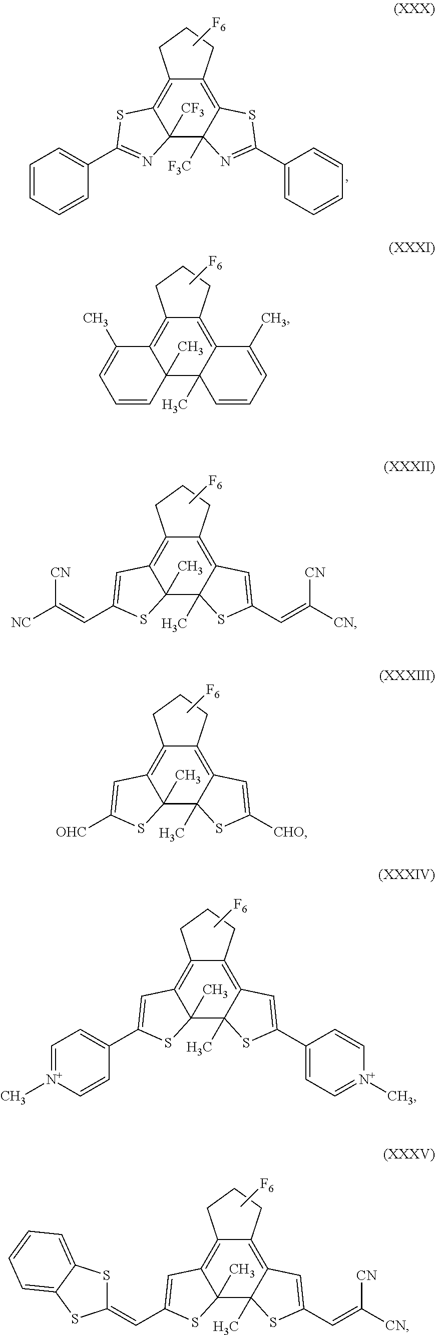

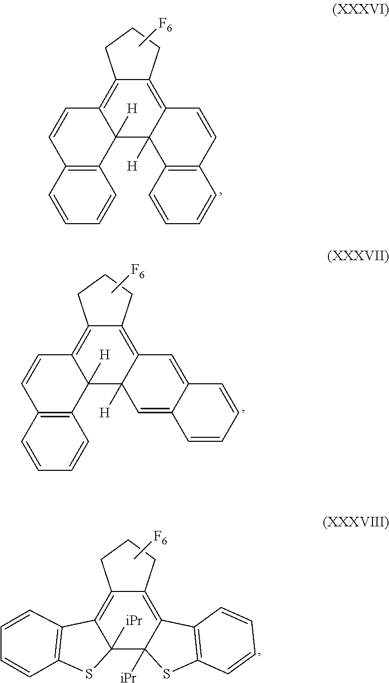

where iPr represents isopropyl;

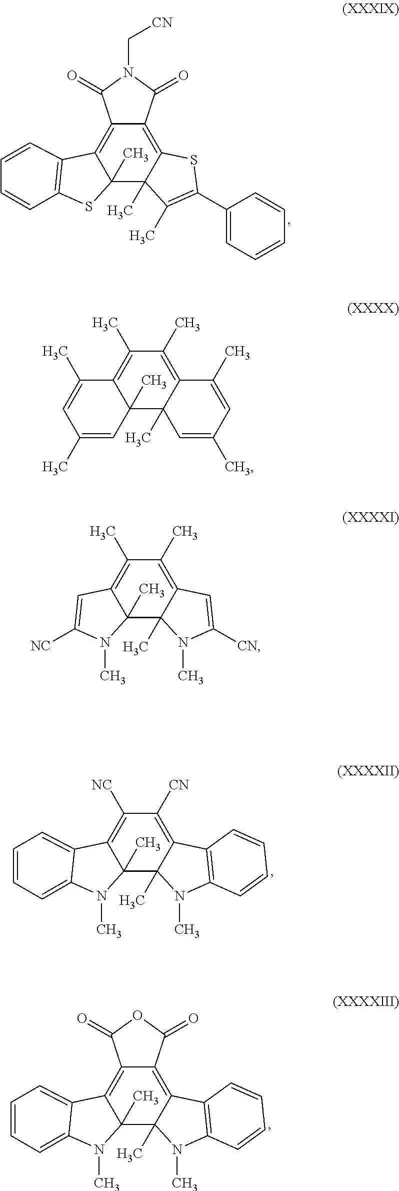

and combinations comprising at least one of the foregoing diarylethenes.

Diarylethenes with five-membered heterocyclic rings have two conformations with the two rings in mirror symmetry (parallel conformation) and in C₂ (antiparallel conformation). In general, the population ratio of the two conformations is 1:1. In one embodiment, it is desirable to increase the ratio of the antiparallel conformation to facilitate an increase in the quantum yield, which is further described in detail below. Increasing the population ratio of the antiparallel conformation to the parallel conformation can be accomplished by covalently bonding bulky substituents such as the —(C₁-C₅ alkyl)COOH substituent to diarylethenes having five-membered heterocyclic rings.

In another embodiment, the diarylethenes can be in the form of a polymer having the general formula (XXXXIV) below. The formula (XXXXIV) represents the open isomer form of the polymer.

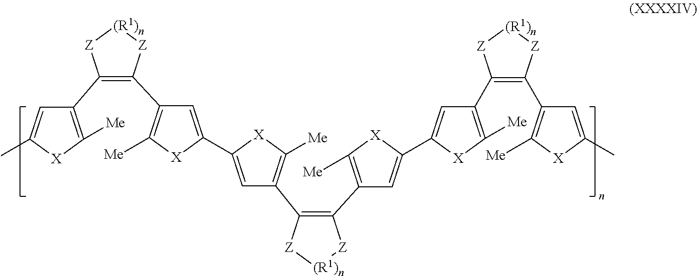

where Me represents methyl, R′, X and Z have the same meanings as explained above in formulas (XI) through (XV) and n is any number greater than 1.

Polymerizing the diarylethenes can also be used to increase the population ratio of the antiparallel conformations to the parallel conformations.

The diarylethenes can be reacted in the presence of light. In one embodiment, an exemplary diarylethene can undergo a reversible cyclization reaction in the presence of light according to the following equation (I):

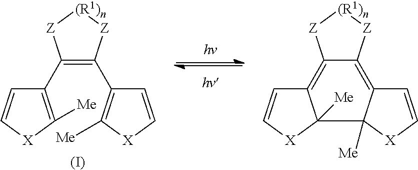

where X, Z, R¹, and n have the meanings indicated above; and wherein Me is methyl. The cyclization reaction can be used to produce a hologram. The hologram can be produced by using radiation to react the open isomer form to the closed isomer form or vice-versa.

A similar reaction for an exemplary polymeric form of diarylethene is shown below in the equation (II)

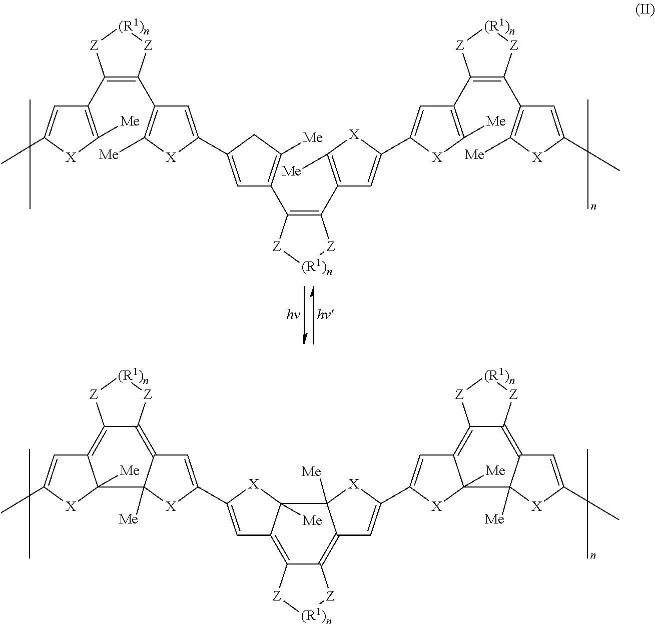

where X, Z, R¹, and n have the meanings indicated above; and wherein Me is methyl.

Nitrones can also be used as photoreactive dyes in the holographic storage media. Nitrones have the general structure shown in the formula (XXXXV):

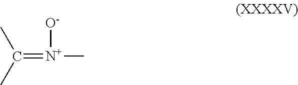

An exemplary nitrone generally comprises an aryl nitrone structure represented by the formula (XXXXVI):

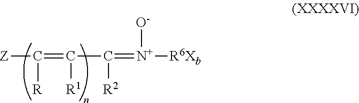

wherein Z is (R³)ₐ-QR⁴— or R⁵; Q is a monovalent, divalent or trivalent substituent or linking group; wherein each of R, R¹, R² and R³ is independently hydrogen, an alkyl or substituted alkyl radical containing 1 to about 8 carbon atoms or an aromatic radical containing 6 to about 13 carbon atoms; R⁴ is an aromatic radical containing 6 to about 13 carbon atoms; R⁵ is an aromatic radical containing 6 to about 20 carbon atoms which have substituents that contain hetero atoms, wherein the hetero atoms are at least one of oxygen, nitrogen or sulfur; R⁶ is an aromatic hydrocarbon radical containing 6 to about 20 carbon atoms; X is a halo, cyano, nitro, aliphatic acyl, alkyl, substituted alkyl having 1 to about 8 carbon atoms, aryl having 6 to about 20 carbon atoms, carbalkoxy, or an electron withdrawing group in the ortho or para position selected from the group consisting of

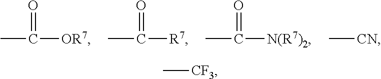

where R⁷ is a an alkyl radical having 1 to about 8 carbon atoms; a is an amount of up to about 2; b is an amount of up to about 3; and n is up to about 4.

As can be seen from formula (XXXXVI), the nitrones may be α-aryl-N-arylnitrones or conjugated analogs thereof in which the conjugation is between the aryl group and an α-carbon atom. The α-aryl group is frequently substituted, most often by a dialkylamino group in which the alkyl groups contain 1 to about 4 carbon atoms. The R² is hydrogen and R⁶ is phenyl. Q can be monovalent, divalent or trivalent according as the value of “a” is 0, 1 or 2. Illustrative Q values are shown in the Table 1 below.

TABLE 1

| Valency of Q | Identity of Q |
|---|---|
| Monovalent | fluorine, chlorine, bromine, iodine, alkyl, aryl; |
| Divalent | oxygen, sulphur, carbonyl, alkylene, arylene. |
| Trivalent | Nitrogen |

It is desirable for Q to be fluorine, chlorine, bromine, iodine, oxygen, sulfur or nitrogen.

Examples of nitrones are α-(4-diethylaminophenyl)-N-phenylnitrone; α-(4-diethylaminophenyl)-N-(4-chlorophenyl)-nitrone, α-(4-diethylaminophenyl)-N-(3,4-dichlorophenyl)-nitrone, α-(4-diethylaminophenyl)-N-(4-carbethoxyphenyl)-nitrone,α-(4-diethylaminophenyl)-N-(4-acetylphenyl)-nitrone, α-(4-dimethylaminophenyl)-N-(4-cyanophenyl)-nitrone, α-(4-methoxyphenyl)-N-(4-cyanophenyl)nitrone, α-(9-julolidinyl)-N-phenylnitrone, α-(9-julolidinyl)-N-(4-chlorophenyl)nitrone, α-[2-(1,1-diphenylethenyl)]-N-phenylnitrone, α-[2-(1-phenylpropenyl)]-N-phenylnitrone, or the like, or a combination comprising at least one of the foregoing nitrones. Aryl nitrones are particularly useful in the compositions and articles disclosed herein. An exemplary aryl nitrone is α-(4-diethylaminophenyl)-N-phenylnitrone.

Upon exposure to electromagnetic radiation, nitrones undergo unimolecular cyclization to an oxaziridine as shown in the structure (XXXXVII)

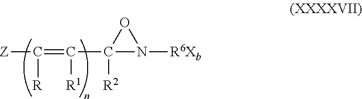

wherein R, R¹, R², R⁶, n, X_{b} and Z have the same meaning as denoted above for the structure (XXXXVI).

Nitrostilbenes and nitrostilbene derivatives may also be used as photoreactive dyes for recording interference fringe patterns, as disclosed for example by C. Erben et al., “Ortho-Nitrostilbenes in Polycarbonates for Holographic Data Storage,” Advanced Functional Materials, 2007, 17, 2659-66, and in U.S. Pat. App. Publ. No. 2008/0085492 A1, the disclosures of which are incorporated herein by reference in their entirety. Specific examples of such dyes include 4-dimethylamino-2′,4′-dinitrostilbene, 4-dimethylamino-4′-cyano-2′-nitrostilbene, 4-hydroxy-2′,4′-dinitrostilbene, and 4-methoxy-2′,4′-dinitrostilbene. These dyes have been synthesized and optically induced rearrangements of such dyes have been studied in the context of the chemistry of the reactants and products as well as their activation energy and entropy factors. J. S. Splitter and M. Calvin, “The Photochemical Behavior of Some o-Nitrostilbenes,” J. Org. Chem., vol. 20, pg. 1086 (1955). More recent work has focused on using the refractive index modulation that arises from these optically induced changes to write waveguides into polymers doped with the dyes. McCulloch, I. A., “Novel Photoactive Nonlinear Optical Polymers for Use in Optical Waveguides,” Macromolecules, vol. 27, pg. 1697 (1994).

In addition to the binder and the photoreactive dye, the holographic recording medium may include any of a number of additional components, including but not limited to heat stabilizers, antioxidants, light stabilizers, plasticizers, antistatic agents, mold release agents, additional resins, binders, and the like, as well as combinations of any of the foregoing components.

In one exemplary embodiment, the holographic recording medium is extruded as a relatively thin layer or film, e.g., having a thickness of 0.5 to 1000 microns. In another exemplary embodiment, a layer or film of the holographic recording medium is coated onto, co-extruded with, or laminated with a support. The support may be a planar support such as a film or card, or it may be virtually any other shape as well. In yet another exemplary embodiment, the holographic medium may be molded or extruded into virtually any shape capable of being fabricated by plastic manufacturing technologies such as solvent-casting, film extrusion, biaxial stretching, injection molding and other techniques known to those skilled in the art. Still other shapes may be fabricated by post-molding or post-extrusion treatments such as cutting, grinding, polishing, and the like.

Holograms as described herein may be incorporated in molded articles having a shape determined by the function of the article. In general, the molded article may be anything that is made from a moldable polymeric material (for example polycarbonate, polyester, etc.) where it is desirable to provide confirmation of the authenticity of the article. Examples of such molded articles can include, without limitation, credit cards, identifications, passports, media discs (for example CDs, DVDs, etc), housings for electronic equipment (e.g., USB drives, recorders, cellular telephones, and the like) and plastic components used in brand/logo tags, and the like. The molded articles described herein are at least partially formed from or at least partially coated with a holographic recording medium in which a transmission hologram can be formed. Also disclosed are methods directed to recording the holograms into the holographic recording medium, whether the molded articles are at least partially formed from the medium or at least partially coated with it. The methods enable recording of color transmission holograms into the volumetric holographic recording medium and provide the ability to control the color that is seen in the hologram. The color can be used to create distinctive color features, or can be used to shade surfaces that create the impression of three dimensional (3D) structures in the holographic image. Due to the complexity in image, recording, and color of these transmission holograms, they serve as strong authentication devices when incorporated into the structure of the molded article. Examples of molding can include injection molding, blow molding, compression molding, vacuum forming, or the like. Examples of processes by which the holographic recording medium can be coated onto the surface of the article include painting (e.g., brush, spray), dip coating, spin coating, or the like.

When the holographic recording medium is disposed upon an article surface as described above, the holographic recording medium can form a film having a thickness of less than or equal to about 100 millimeters (mm); specifically 1 micrometer (nm) to about 10 mm; more specifically 3 μm to 1 mm; still more specifically 7 μm to about 500 nm.

In one embodiment, the molded article comprises the holographic recording material. For example, the holographic recording composition can be incorporated into an organic polymer in a mixing process to form the composition of the article. Following the mixing process, the composition can be formed into the desired article (e.g., sheet, complex 3D article having areas of different thickness, etc.). For example, the composition can be injection molded into an article into which the volume hologram can be recorded. The injection molded article can have any geometry. Exemplary geometries include, without limitation, sheets, circular discs, square shaped plates, polygonal shapes, and the like.

The present disclosure is further illustrated by the following non-limiting example.

### EXAMPLES

The holographic recording medium was exposed with a 405 nm, 30 mW, external cavity diode laser, split with a beam splitter and directed through a series of mirrors and lenses to direct signal and reference beams onto the holographic recording medium at an angle of incidence of 5.1° for the signal beam and 33.7° for the reference beam, providing an angle of separation of 38.8° between the two beams. Half wave plates (HWP) and quarter wave plates (QWP) were used to control the polarization of the light during recording, and the polarization beam splitter (PBS) was used to control the intensities of the signal and reference beams for optimal hologram brightness. Lenses were used for both beam expansion and image formation, to yield the desired hologram size as well as to guarantee the hologram was in focus. Blue, green, and red component planes of a full color test image were digitized and provided to a spatial light modulator (SLM) for modulation of the signal beam during exposure.

Although the required modification of the exposure angles could be calculated using Bragg's Law and Snell's law, the angles for this example were determined empirically using the following procedure. After testing the color control in the hologram, experiments were conducted to determine the incident angle at which the holographic material can be positioned so that red, green, and blue colors could be generated. By generating red, green, and blue, it would then be possible to create true color holograms. Color mixing was demonstrated by recording overlapping circles at different angles, thus determining the angular spacing of the primary colors, red, green, and blue. It was found that, when using a 120 millimeter diameter, 0.6 mm thick round plastic disc molded from a polycarbonate thermoplastic composition containing 1.5 wt. % α-styrenyl isopropyl nitrone in PC 100 polycarbonate, the red, green and blue colors were separated by 2°; an incident angle of −2° gave blue wavelength holograms, 0° gave green wavelength holograms, and 2° gave red wavelength holograms. This was demonstrated by recording one circle of the red wavelength and overlapping it with a second circle of the green. The overlap between the circles should have been yellow, which it was, thereby demonstrating color mixing. This identification of the angular spacing of the primary colors was then tested using a full color test image.

A full color image of a United States flag was drawn with a standard drawing program. The image was then separated into its color planes. The red plane hologram, green plane hologram, and blue plane hologram were recorded, each separated by 2° of incident angle, provided by rotating the holographic recording medium 2° between each exposure while making no changes to the configuration/direction of the exposure optics. FIGS. 5-7 show the individual color planes blue, green, and red, respectively. After recording the three color planes, the image resulted in a true color version of the flag when viewed at an angle of approximately 90° using a diffuse full spectrum white light source. The true red, green and blue colors were only visible when a diffuse light source was passed through hologram at the correct angle (45°) and distance (approximately 2.5 cm for a diffused LED lamp source (single emitter, 0.5 cm×0.5 cm, parabolic reflector).

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A method for recording a volume transmission hologram, comprising:
recording a first interference fringe pattern by exposing a holographic recording medium to a signal coherent light source emitting light at a wavelength W and having an angle of incidence with the holographic recording medium of θ_{S1} while simultaneously exposing the holographic recording medium to a mutually coherent reference light source on the same side of the holographic recording medium as the signal coherent light source, the reference coherent light source emitting light at the wavelength W and having an angle of incidence with the holographic recording medium of θ_{R1}; and
recording a second interference fringe pattern by exposing the holographic recording medium to a signal coherent light source emitting light at the wavelength W and having an angle of incidence with the holographic recording medium of θ_{S2} while simultaneously exposing the holographic recording medium to a mutually coherent reference light source on the same side of the holographic recording medium as the signal coherent light source, the reference coherent light source emitting light at the wavelength W and having an angle of incidence with the holographic recording medium of θ_{R2}, wherein at least one of θ_{S1} and θ_{R1} is different from θ_{S2} and θ_{R2}, respectively.

2. The method of claim 1, further comprising rotating the holographic recording medium relative to the signal and reference light sources after recording the first interference fringe pattern and before recording the second interference fringe pattern, thereby providing angles of incidence θ_{S2} and θ_{R}² that are different than angles of incidence θ_{S1} and θ_{R1}, respectively.

3. The method of claim 1, wherein the first and second interference fringe patterns are spatially multiplexed.

4. The method of claim 1, wherein the first interference fringe pattern diffracts light at a first wavelength λ₁ when the holographic recording medium is illuminated from an angle Φ_{I1} and viewed from an angle Φ_{V}, and the second interference fringe pattern diffracts light at a second wavelength λ₂ when the holographic recording medium is illuminated from an angle Φ_{I2} and viewed from the angle Φ_{V}.

5. The method of claim 4, wherein light at the first wavelength λ₁ diffracted by the first interference fringe pattern and light at the second wavelength λ₂ diffracted by the second interference fringe pattern cooperate to display a predetermined display feature when the holographic recording medium is illuminated by non-collimated light comprising wavelengths λ₁ and λ₂ from angles Φ_{I1} and Φ_{I2} and viewed from angle Φ_{V}.

6. The method of claim 5, wherein the first and second interference fringe patterns are spatially multiplexed.

7. The method of claim 5, wherein the predetermined display feature is a security feature.

8. The method of claim 5, wherein the predetermined display feature is a multicolor rendering of a color image in the wavelengths λ₁ and λ₂.

9. The method of claim 1, further comprising recording a third interference fringe pattern by exposing the holographic recording medium to a signal coherent light source emitting light at the wavelength W and having an angle of incidence with the holographic recording medium of θ_{S3} while simultaneously exposing the holographic recording medium to a mutually coherent reference light source on the same side of the holographic recording medium as the signal coherent light source, the reference coherent light source emitting light at the wavelength W and having an angle of incidence with the holographic recording medium of θ_{R3}.

10. The method of claim 9, further comprising rotating the holographic recording medium relative to the signal and reference light sources between recording of the first and second interference fringe patterns and between recording the second and third interference fringe patterns thereby providing angles of incidence θ_{S2} and θ_{R2}, and θ_{S3} and θ_{R3} and that are different from each other and different than angles of incidence θ_{S1} and θ_{R1}, respectively.

11. The method of claim 9, wherein the first interference fringe pattern diffracts light at a first wavelength λ₁ when the holographic recording medium is illuminated from an angle Φ_{I1} and viewed from an angle Φ_{V}, the second interference fringe pattern diffracts light at a second wavelength λ₂ when the holographic recording medium is illuminated from angle Φ_{I2} and viewed from angle Φ_{V}, and the third interference fringe pattern diffracts light at a third wavelength λ₃ when the holographic recording medium is illuminated from angle Φ_{I3} and viewed from angle Φ_{V}.

12. The method of claim 9, wherein the first, second, and third interference fringe patterns are spatially multiplexed.

13. The method of claim 9, wherein light at the first wavelength λ₁ diffracted by the first interference fringe pattern, light at the second wavelength λ₂ diffracted by the second interference fringe pattern, and light at the third wavelength λ₃ diffracted by the third interference fringe pattern cooperate to display a predetermined display feature when the holographic recording medium is illuminated by non-collimated light comprising wavelengths λ₂, and λ₃ from angles Φ_{I1}, Φ_{I2}, and Φ_{I3}, and viewed from angle Φ_{V}.

14. The method of claim 13, wherein the first, second, and third interference fringe patterns are spatially multiplexed.

15. The method of claim 13, wherein the predetermined display feature is a security feature.

16. The method of claim 9, wherein one of wavelengths λ₁, λ₂, and λ₃ is red, another of wavelengths λ₁, λ₂, and λ₃ is blue, and another of wavelengths λ₁, λ₂, and λ₃ is green.

17. The method of claim 12, wherein light at the first wavelength λ₁ diffracted by the first interference fringe pattern, light at the second wavelength λ₂ diffracted by the second interference fringe pattern, and light at the third wavelength λ₃ diffracted by the third interference fringe pattern cooperate to display a full color rendering of an image.

18. The method of claim 1, further comprising recording one or more additional interference fringe patterns by exposing the holographic recording medium to mutually coherent signal and reference beams at wavelength W having angles of incidence with the holographic recording medium of θ_{Sx} and θ_{Rx}, wherein x represents the number of each additional exposure, and wherein at least one of each θ_{Sx} and θ_{Rx} is different from at least one of θ_{S1} and θ_{R1}, respectively, and from at least one of θ_{Sx} and θ_{Rx} used to form any other additional interference fringe patterns, such that each additional interference fringe pattern diffracts light at a different wavelength λₓ when viewed at an angle Φ_{V} under illumination by non-collimated light.

19. A holographic article produced by the process of claim 1.

20. A holographic article produced by the process of claim 3.

21. A holographic article produced by the process of claim 4.

22. A holographic article produced by the process of claim 5.

23. A holographic article produced by the process of claim 8.

24. A holographic article produced by the process of claim 9.

25. A holographic article produced by the process of claim 11.

26. A holographic article produced by the process of claim 12.

27. A holographic article produced by the process of claim 13.

28. A holographic article produced by the process of claim 14.

29. A holographic article produced by the process of claim 16.

30. A holographic article produced by the process of claim 17.

31. A holographic article produced by the process of claim 18.
